(19) United States
(12) Patent Application Publication
(10) Pub. No.: US 2010/0104791 A1
(43) Pub. Date: Apr. 29, 2010

(54) METHOD FOR THE ANTIMICROBIAL PROTECTION OF AN OBJECT USING AN ANTIMICROBIAL PRESSURE-SENSITIVE ADHESIVE PLASTICS FILM

(75) Inventors: Christophe Baudrion, Bouzigues (FR); Frederic Masson, Loupian (FR); Michel Mateu, Balaruc Le Vieux (FR)

Correspondence Address: DENNISON, SCHULTZ & MACDONALD, 1727 KING STREET, SUITE 105, ALEXANDRIA, VA, 22314, US

(73) Assignee: HEXIS, Frontignan (FR)

(21) Appl. No.: 12/522,327

(22) PCT Filed: Jan. 11, 2008
(86) PCT No.: PCT/FR2008/050056

§ 371 Date: Jul. 7, 2009

(30) Foreign Application Priority Data
Feb. 8, 2007 (FR) 0700884

(51) Int. Cl. B32B 7/12; B32B 27/30; B32B 5/00

(52) U.S. Cl. 428/41.8; 428/343; 428/339; 428/522; 156/327

(57) ABSTRACT

A method for the antimicrobial protection of a plane or non-plane surface of a material object, i.e. other than a human or animal body. An inner face of a self-adhesive plastics film is coated with a layer of adhesive and applied against the surface of the object, the film being constituted by plasticized PVC including a polymeric plasticizer. The film is flexible and manually stretchable and capable of following the contour of the surface, has an elongation at break of more than 50% and an ultimate tensile strength of less than 6000 N/m. The film incorporates in its material or includes on its outer surface an antimicrobial agent rendering the outer surface of the film active against microbes.

The present invention relates to a method for the antimicrobial protection of a surface of an object and to an antimicrobial self-adhesive plastics film for use in this method.

Paints and varnishes are known that have antimicrobial properties for use in protecting all types of surfaces, but essentially in the architectural field for providing protection against mosses and fungi and in the maritime field for providing protection to shipping hulls against algae and fouling in general, as described in U.S. Pat. No. 4,221,839, U.S. Pat. No. 6,559,202, or U.S. Pat. No. 6,251,967. Such paints and varnishes are applied directly to an object to be protected. Such coatings of paint or varnish incorporate an antimicrobial agent within their material to provide them with a long-lasting antimicrobial effect. The antimicrobial agent that is incorporated into said coating at or near to the surface exerts an antimicrobial action against damaging external microbial agents in contact with the outer surface of said paint or varnish coating. In addition, microbial agents that are further from the outer surface of the coating can migrate towards the outer surface of the coating or close to it as it is consumed at or near the surface.

However, that technique for antimicrobial protection suffers from a certain number of disadvantages:
all the disadvantages connected with handling a relatively toxic liquid chemical including solvents that are damaging to the environment, whether for storage, transport, or during application;
applying a paint or varnish is relatively skilled, requiring qualified or specialized personnel such as painters, since obtaining the right results and durability depend on the quality and conditions for application. Further, applying a paint or varnish is a lengthy process and moreover, requires additional drying time; and
antimicrobial paints and varnishes require relatively frequent renewal because such coatings do not have good strength and durability properties and also because the antimicrobial agent acts over a limited period, since the period during which the antimicrobial action of the coating is active is linked to the quantity of antimicrobial agent it contains. Furthermore, the conditions for renewing a paint or varnish type coating require prior elimination by stripping of the surface of the object to be protected before any fresh application.

Further, antimicrobial films or varnishes that are non-renewably incorporated into certain products are known, in particular for the manufacture of gloves (WO-98/30094, U.S. Pat. No. 5,725,867), garbage containers (U.S. Pat. No. 6,610,763), identity bracelets (WO-2006/116670), catheters (U.S. Pat. No. 5,091,442 and U.S. Pat. No. 5,772,640), or toothbrushes (U.S. Pat. No. 6,108,847). They constitute antimicrobial treatments carried out in the manufacturing process during the industrial production of said objects. Those treatments are thus complex and the end user cannot carry them out directly and simply; and is even less able to renew them.

In addition, films with antimicrobial properties are known in the hospital field, such as in surgical drapes and dressings. However, they are solely intended for temporary application to human skin, in particular in U.S. Pat. No. 4,542,012, U.S. Pat. No. 5,069,907, U.S. Pat. No. 5,853,750, U.S. Pat. No. 6,216,699, U.S. Pat. No. 6,700,032, and U.S. Pat. No. 6,838,078. Thus, they do not constitute films that are suitable for protecting all types of surfaces.

In such applications as dressings or surgical drapes, the active antimicrobial substance need to be released rapidly at the surface of a film in contact with the patient's skin so that it can act on the skin that is in contact with the applied film.

Thus, there is now a need for a product or a method that can rapidly, easily, durably, and in a renewable manner protect all types of surfaces against microbial colonization.

The problem of the present invention is to provide a method for durable antimicrobial protection that can be applied to and renewed at the surfaces of all types of objects with a plane or non-plane surfaces, that is not incorporated into the product itself and that:
is easier and safer to use in terms of storage, transport and application;
has application conditions that do not require skilled or specialized personnel, and in which the quality of the coating and the desired antimicrobial effect do not depend on the quality of its application; and
has better properties of wear resistance and durability, requiring renewal that is less frequent and that is simple to carry out.

To this end, the present invention provides a method for the antimicrobial protection of a plane or non-plane surface of a material object, i.e. other than a human or animal body, characterized in that the face termed the inner face of a self-adhesive plastics film (1) coated on its face termed the inner face with a layer of adhesive (2) is applied against the surface of the object, said film being constituted by plasticized polyvinyl chloride (PVC), said film being flexible and manually stretchable and capable of following the contour of a said surface, having an elongation at break of more than 50% and an ultimate tensile strength of less than 6000 newtons per meter (N/m), and said film incorporating in its material or comprising on its surface termed the outer surface an antimicrobial agent rendering the outer surface of said film active against microbes.

It should be understood that the outer face or surface corresponds to the opposite face or surface that faces outwards and that is not coated with adhesive.

The term “antimicrobial protection” as used here means that it is not intended per se to remove microbes from the object coated with said film, but rather to use the film that is applied to its surface, to render the outer surface of the object active against microbes so as to prevent the development and propagation of said microbes by contact with the surfaces of said objects.

In accordance with the original concept of the present invention, the outer surface of a self-adhesive film takes the place of the contact surface of an object in order to render it active against microbes.

The method of the present invention can provide reliable, durable, easy, and rapidly implemented antimicrobial protection for any type of plane or non-plane surface. A film in accordance with the invention also guarantees uniformity of the antimicrobial effect independently of the conditions of its application by personnel.

The method of the invention is particularly advantageous for protecting of a non-plane surface. Due to its constitution, the manually self-adhesive film may also be stretched thermally, i.e. by heating.

Due to its self-adhesive nature, the film and thus the surface antimicrobial protection, can easily be applied by unqualified personnel or by a person without specific equipment. Similarly, the film can be removed as easily as it was applied and then replaced, again without specific equipment, in particular to renew the protection when the antimicrobial agent is exhausted. Because it is incorporated into a polymeric matrix (the material of the film or of a varnish), the antimicrobial effect is long-lasting, in general over at least a few months, especially at least 3 months, or even several years since the antimicrobial agent can only migrate relatively slowly towards the surface over time. The frequency at which the film is renewed depends, inter alia, on the amount of antimicrobial agent incorporated in the film.

Further, the flexibility and aptitude to elongation of the adhesive film means that it can be applied to surfaces with complex shapes. The film can follow highly curved or angular surfaces, in particular with right angles or acute angles, such as the surfaces of door handles or table legs of circular section as examples of highly curved surfaces, or the edges or the edge faces of table tops, or table legs of rectangular section or even of triangular section, as examples of plane surfaces with angular edges.

The terms used here have the following meanings:
“stretchable” means a film with elongation at break of more than 50%; and
“manually stretchable” means a film that also has an ultimate tensile strength of less than 150 newtons per inch (N/inch) (i.e. less than approximately 6000 N/m).

The film must be stretchable, but this stretching must not require too high a tensile force in order for it to be done manually.

These parameters are measured by stretching the film using a dynamometer and by measuring the elongation required for it to break (French standard NF 41-025, 1984) and the tensile force required to break it (French standard NF 41-021). These values are given in N/inch for the ultimate tensile strength and by percentage elongation for the elongation at break.

Herein, a film is considered to be sufficiently stretchable and can be readily applied, in particular manually stretched over a highly curved or angular surface if its elongation at break is more than 50% and its ultimate tensile strength is less than 150 N/inch.

These elongation at break and ultimate tensile strength properties that are less than the above-indicated limiting values are obtained by using an amount of plasticizer in the PVC film of more than 0.1% by weight, preferably 5% to 50%.

More particularly, said surface of the object is made of a material selected from wood, rigid plastics materials, minerals such as plaster, cement or other facings, or metals. Further, said object is a household object, an item of furniture or an indoor fitting for a building, preferably for public areas that are exposed to the risk of contamination by contact with said objects.

Items of furniture that may be mentioned are tables, seating and desks, and indoor fittings for buildings that may be mentioned are walls, ceilings, floors, doors, and windows.

More particularly, the applications envisaged by the present invention are the protection of all surfaces located in premises exposed to the risks of contamination, in particular in premises where microbial colonization presents a health risk and cannot be disinfected sufficiently frequently, in particular in hospitals and other premises of a medical nature, nurseries, canteens, schools, and more particularly entrance halls, reception desks, on doors, walls, floors, seating, windows, various items of furniture, computer equipment, signage and advertising panels, and kitchen and bathroom elements.

Advantageously, the film also includes dyes or decorative printing or text on its outer surface.

It may thus also act as a medium for decoration and/or communication. As an example, it may replace wallpaper and paint, in particular wall paint. If the decoration or visual communication element is no longer relevant, the film can be replaced easily and in a regular manner.

Self-adhesive films of this type but that do not incorporate an agent with an antimicrobial effect on external contamination by contact are known in the fields of decoration and communication, and in a very large number of other applications such as in applications for protecting the edges of painted surfaces, sealing systems in the packaging field, protective adhesives in the electrical field, labels in the commercial and stationery fields, and the furniture field with laminated films providing wood or other decorative effects.

Self-adhesive films for decorative use are colored, written or imaged media having on their inner face a layer of adhesive enabling them to be fixed to a surface either temporarily or permanently. Until the adhesive has been applied, the adhesive portion is covered by a protection termed a liner. When the films are colored, they generally serve to decorate surfaces. They can be cut out using computer aided cutting (CAC) to produce shapes or letters. They are generally intended to be printed or screen printed to act as labels and advertising posters. They now replace paint in many applications such as interior and exterior surfaces on public transport (trains, metros, buses, tramways). They are considered to be advertising media that are intended to be in position for long periods.

Plastics films are usually constituted by polyolefins such as polyethylenes or polypropylenes, polyesters, in particular polyethylene terephthalate (PET), acrylic polymers, polyurethanes and polyvinyl chloride (PVC) formulations.

Polyolefin films have the advantage of being inexpensive, easy to stretch and conformable, and so they can be applied to surfaces that are not plane. However, they suffer from the major disadvantage of not having high resistance to external attack and thus cannot readily be used for long periods. Since their surfaces are relatively inert, printing them and rendering them adhesive requires a prior surface treatment.

PET has excellent transparency, but its surface is impermeable to ink, so it is necessary to deposit an additional layer to allow it to receive printing. It is rigid and it is impossible to apply it to surfaces that are not plane. It is generally intended for application to window glass and to transparent plane surfaces.

Films of acrylic polymers and polyurethanes may be used, but they are very expensive.

According to the present invention, as mentioned above, a film of plasticized PVC is used, since this has the advantage of being readily stretchable and thus of being capable of being applied easily, since pure PVC would be too rigid and brittle.

According to the present invention, the film itself is rendered active for a sufficient period of time by controlling migration of the active substance from the film or varnish. To this end, employing a polymeric plasticizer rather than a monomeric plasticizer is advantageous because it means that migration of the plasticizer can be reduced, which migration can lead to migration of the antimicrobial agent when such an agent is included in the material of the PVC, or to degradation of the varnish, or to detachment of the film.

In fact, a monomeric plasticizer has a large tendency to evaporate, to migrate, and thus to be removed from the PVC. It can migrate towards the surface, taking with it the antimicrobial agent present in the PVC, which thus limits the durability of the antimicrobial effect of the film. If the plasticizer migrates towards the surface, it also risks contaminating persons coming into contact with the film and rendering the PVC tacky. In contrast, if the plasticizer migrates inwardly, it penetrates into the adhesive, softens it and finally it causes the film to detach.

Another disadvantage of a monomeric plasticizer is that because of its migration, its concentration reduces in the PVC film, which then stiffens and crazes.

Further, a monomeric plasticizer is generally an aromatic molecule, in particular a phthalate derivative, that rapidly turns yellow when exposed to UV, outdoors or behind window glass, as could happen in the application of the present invention. Additionally, because they are applied to the objects, the films of the invention have a decorative function.

Finally, exudation of the plasticizer risks degrading the varnish when the active substance is in a varnish applied to the outer surface of the film.

As a result, in order to produce a durable antimicrobial plasticizing PVC film, it is preferable to use a polymeric plasticizer.

These plasticized PVC films may be obtained using two methods:
calendering, as described in the Handbook of Plastic Materials and Technologies, edited by I. Rubin, Wiley & Sons, Inc, New York, 1990. PVC granules are blended with various additives and then heated and mixed to form a gelled strip which is fed to a calender. The calender is constituted by two cylinders rotating in opposite directions between which the hot PVC formulation flows. A film is produced that is pulled to obtain the desired thickness, in general in the range 50 μm [micrometer] to 500 μm. A plasticized PVC film with a thickness of 80 μm has, for example, an elongation at break of more than 100% for 40 N/inch in the transverse direction. Since the film has been stretched in the longitudinal direction during its production, its elongation at break is higher and its ultimate tensile strength is lower in the transverse direction than in the longitudinal direction;
coating, generally known as cast PVC. These types of films are produced from PVC powders blended with additives similar to those for calendering, and with solvents. This forms a PVC paste that is spread in line on a smooth support and passes into an oven in order to obtain the film that is then removed from its support for rolling up. This film has an elongation at break that is identical in both directions, which is more advantageous for application thereof to curved surfaces. For conformability reasons, a PVC film obtained using the cast method is preferred.

In general, plasticized PVC films are constituted by the following components:

1) a polyvinyl chloride with a mass average molar mass of 100000 to 250000;

2) plasticizing compounds present in an amount by weight of 5% to 50% that are termed external since they are not present in the PVC chain but free in the polymer;

3) if appropriate, organic dyes or inorganic pigments. The former generally have poor stability to UV, and so the latter are preferred for long-term out-door applications;

4) preferably, thermal or UV stabilizing agents which ensure good behavior of the film and good resistance to external conditions of temperature and exposure to light. More particularly, they are present in an amount by weight of 0.1% to 5%. Yet more particularly, two types of UV stabilizers exist: UV absorbers that act to capture UV radiation instead of the polymer, and radical scavengers that recover free radicals that appear in the film and prevent them from destroying it; and

5) various additives facilitating production of the film. They may be anti-foaming agents, surfactants, slip agents, agents that facilitate the dispersion of pigments, inter alia.

As mentioned above, plasticizers that are termed monomeric plasticizers constituted by molecules with a low molecular mass, such as esters or phthalates, are known. In particular, dioctyl phthalate (DOP), or di(2-ethylhexyl)phthalate, diisodecyl phthalate (DIDP), dinonyl phthalate (DNP) are known. Those monomeric plasticizers suffer from the disadvantage of migrating out of the PVC during use, and apart from eco-toxicological considerations, that causes the PVC to stiffen and ultimately destroys it. PVC films produced from such plasticizers are known in the art as “monomeric PVC”.

In accordance with the present invention, and as mentioned above, the plasticizer is preferably a polymeric plasticizer, i.e. a high molecular mass molecule such as a polyester. These polymers have molar mass of 500 to 15000. This high molar mass prevents them from migrating through the PVC, which produces better durability. This PVC is known in the art as “polymeric PVC”.

Because of the properties discussed above, in the present invention a plasticized PVC is preferred that includes a polymeric plasticizer to prevent any exudation of the plasticizer and, if appropriate, to prevent too rapid a migration of the antimicrobial active substance included in the material of the PVC.

More particularly, said polymeric plasticizer is preferably selected from polyesters obtained by reaction of a diol on a dibasic acid.

It is generally a polyester or a mixture of polyesters obtained by reaction of glycols or mixtures of glycols, for example ethylene glycol, 1,2-propylene glycol, 1,3-butylene glycol, 1,4-butylene glycol, neopentyl glycol, 1,6-hexanediol, on dibasic acids such as phthalic acid, sebacic acid, azelaic acid, adipic acid, or glutaric acid. More particularly again, a glycol polyadipate may be mentioned. Their molar mass is in the range 500 g/mol to 15000 g/mol, preferably more than 4000 g/mol.

The thickness of the plastics film may be 10 μm to 500 μm, preferably 30 μm to 100 μm. In general, the GSM or mass per unit area of the plastics film is 10 grams per square meter (g/m²) to 1000 g/m², preferably 20 g/m² to 200 g/m².

In a first embodiment, the antimicrobial agent is incorporated into a varnish applied to the outer surface of the plastics film, preferably in an amount by weight of 0.1% to 10%, preferably 0.5% to 5% relative to the weight of said varnish. More particularly, in this first embodiment, the mass per unit area of said antimicrobial agent is 0.01 g/m² to 10 g/m², preferably 0.02 g/m² to 2 g/m², for a layer of varnish of 1 g/m² to 100 g/m², preferably 5 g/m² to 50 g/m².

More particularly, this embodiment is advantageous when the surface of the object, and thus that of the plastics film after application to the object, requires high resistance to chemicals because of the frequent and aggressive cleaning that must be undertaken for hygiene reasons, for example in hospitals.

In a second embodiment, the antimicrobial agent is incorporated into the material of the plastics film, in an amount by weight of 0.1% to 10%, preferably 0.5% to 5% relative to the total film weight. More particularly, for a film of 10 g/m² to 1000 g/m², preferably 20 g/m² to 200 g/m², the GSM or mass per unit area of the antimicrobial agent is 0.01 g/m² to 100 g/m², preferably 0.05 g/m² to 10 g/m².

More particularly, this second embodiment is advantageous when a film is obtained with high elongation at break, in particular more than 100%, in order to be applied to the surfaces of objects with high curvature or large and/or multiple changes of angle.

For this second embodiment, it is preferable to use a PVC film obtained by the casting method, which has the advantage of being very easy to conform.

A UV-cured acrylic varnish that can withstand chemicals cannot have too high an elongation at break, in particular one of more than 100%. In the first embodiment, then, it is neither necessary nor desirable to use a cast plasticized PVC that economically is of less interest than a calendered PVC. Advantageously, the antimicrobial agent is incorporated in a varnish applied to a calendered plasticized PVC film.

Advantageously, the antimicrobial agent is incorporated in a varnish applied to a calendered plasticized PVC film, preferably having an elongation at break of less than 200%, preferably less than 150%.

In this first embodiment, a PVC plasticized with a polymeric plasticizer is preferred in order to avoid any exudation of plasticizer into the varnish that would ultimately cause it to yellow and accelerate degradation thereof.

More particularly, in the first embodiment, for technical and ecological reasons, it is important that the antimicrobial varnish can be deposited easily, can dry rapidly, and does not contain solvents that could evaporate off and contaminate the environment. Radiation-cured varnishes enjoy this type of advantage. Furthermore, they enjoy high chemical resistance.

The composition of the varnish is also selected such that it has a certain elongation on tension even after curing without affecting its chemical resistance and such that it does not excessively reduce the elastic properties of the plastics film, and more particularly so as to render it compatible with support films having 50% to 100% elongation at break.

The radiation-curable varnish comprises a mixture of an oligomer, compounds that can initiate a curing reaction known as photoinitiators, compounds termed chain extenders, a curing agent, and various additives including antimicrobial agents.

It has also been discovered in the present invention that the composition of the varnish has an effect on the antimicrobial properties of the varnish, even if its components do not have any intrinsic antimicrobial activity.

The antimicrobial agent selected must be compatible and in particular soluble in the formulation of the varnish, it must have a spectrum of action that is as broad as possible and it must be capable of being expressed in the cured varnish. Various antimicrobial agents have been tested, for example zinc pyrithione, terbutryn, silver salts, triazines, or triclosan. Once incorporated in an acrylic varnish, triclosan retained a high activity compared with the others.

The varnish is composed of:

a) an oligomer, a polymer with a molar mass of 500 g/mol to 10000 g/mol, preferably 1000 to 5000 g/mol.

This forms the body of the varnish and provides its main properties. It has reactive functions at its ends such as epoxy, maleates, vinyls, or (meth)acrylates, preferably acrylates. The backbone of said polymer may be a polyurethane, a polyacrylic, a polyester, a polyether, a polycarbonate, or an epoxy, preferably a polyester. It is present in concentrations of 15% to 80% by weight in the mixture, preferably in concentrations in the range 20% to 60%. This product is generally very viscous and can be used alone only with difficulty; it is thus vital for it to be diluted in the monomers described below in order to be applied;

b) chain extenders, molecules with low molar masses of less than 500 g/mol, and with a viscosity of less than 300 milli pascal seconds (mPa·s) at 25° C. They must have one and only one acrylate function that is capable of reacting with the selected oligomer. They are intended to reduce the viscosity of the formulation and increase the polymer chain lengths to assure elongation of the varnish and its adhesion to the plasticized PVC.

Examples of monofunctional acrylate monomers are: hydroxyethyl acrylate, isobornyl acrylate, isodecyl acrylate, octyl acrylate and decyl acrylate, and N-butyl-1,2-(acryloyloxy)ethyl carbamate. These compounds are present in the varnish in concentrations in the range 1% to 60%, preferably 5% to 50%;

c) curing agents, monomers with a viscosity of less than 2000 mPa·s at 25° C. containing at least two acrylate functions. These molecules participate in diluting the oligomer and in curing the varnish. In general, the higher their functionality and concentration, the more resistant is the varnish to solvents, but the harder and more brittle it is. Examples of multifunctional acrylate monomers are: hexanediol diacrylate, dipropyleneglycol diacrylate, tripropyleneglycol diacrylate, and trimethylolpropane triacrylate. These compounds are present in the varnish in concentrations in the range 1% to 60%, preferably 5% to 50%;

d) photoinitiators, molecules that are capable of absorbing light and initiating a polymerization reaction. They are selected as a function of their absorption spectrum and of the emission spectrum of lamps used to irradiate the varnish. Examples of photoinitiators are benzophenone, 1-hydroxy-cyclohexylphenyl ketone, 2-hydroxy-2-methyl-1-phenyl-1-propanone, etc. They may be used alone or coupled with other initiators or co-initiators such as tertiary amines. The total of the photoinitiators represents 0.1% to 15% of the formulation, preferably 1% to 10%;

e) the various additives are molecules improving the application or the properties of the varnish. Examples are slip agents, surfactants, wetting agents, anti-foaming agents, UV stabilizers, etc. This set of additives is generally present in concentrations in the range 0.01% to 5%, preferably in the range 0.1% to 3%.

By judicious selection of the oligomer and adjustment of the concentrations of oligomers, chain extenders, and curing agents, the curing and elongation of the varnish can be controlled, as well as its antimicrobial properties. Thus, it has been shown that at equal concentrations of antimicrobial agent, two varnishes do not have the same antimicrobial activity as a function of their composition of oligomers, chain extenders, and curing agents (compare Examples 5 and 7).

Preferably, in accordance with the present invention the antimicrobial agent is incorporated in a varnish based on a polyester oligomer or polyurethane acrylate polymerizable by curing in light. The term “polyester varnish” or “polyurethane acrylate” means a varnish based on an oligomer with a polyester or polyurethane backbone and a reactive acrylic function at the end.

The best results are obtained with a polyester acrylate varnish. These varnishes have the best properties of combined chemical resistance and elasticity.

The varnish is deposited in layers with a thickness in the range 2 micrometers (μm) to 50 μm, more precisely in the range 5 μm to 30 μm on the film, in particular a PVC film. After application of the varnish formulation to the film, it is polymerized by passing it beneath sources emitting light, preferably in the UV region between 200 nanometers (nm) and 400 nm, at speeds in the range 5 meters per minute (m/min) to 500 m/min.

Preferably, in the second embodiment, the antimicrobial agent is incorporated in the material of a plastics film, preferably plasticized PVC, prepared by coating (the cast process described above) and preferably with an elongation at break of more than 100%. The manufacturing method thus consists in incorporating the antimicrobial agent in the polymer formulation constituting said film, especially PVC, which is then dried to obtain the film. Since the antimicrobial agent is directly integrated in the plastics material, the film does not include a superficial layer of varnish.

More particularly, in the second embodiment, a cast PVC formulation is composed as follows:
a polyvinyl chloride powder;
plasticizers;
solvents;
additives;
the antimicrobial agent, preferably triclosan.

The PVC powder is mixed with other compounds to form a fluid paste. This paste can be coated onto a non-stick support such as a silicone support, in the same manner as a coating of adhesive. The assembly passes into an oven to evaporate off the solvents and form the film. Once this operation is complete, the film passes through the same machine again to be coated with adhesive and laminated to a liner as described below. When production is complete, the non-stick support which acted as a support for the PVC paste is removed.

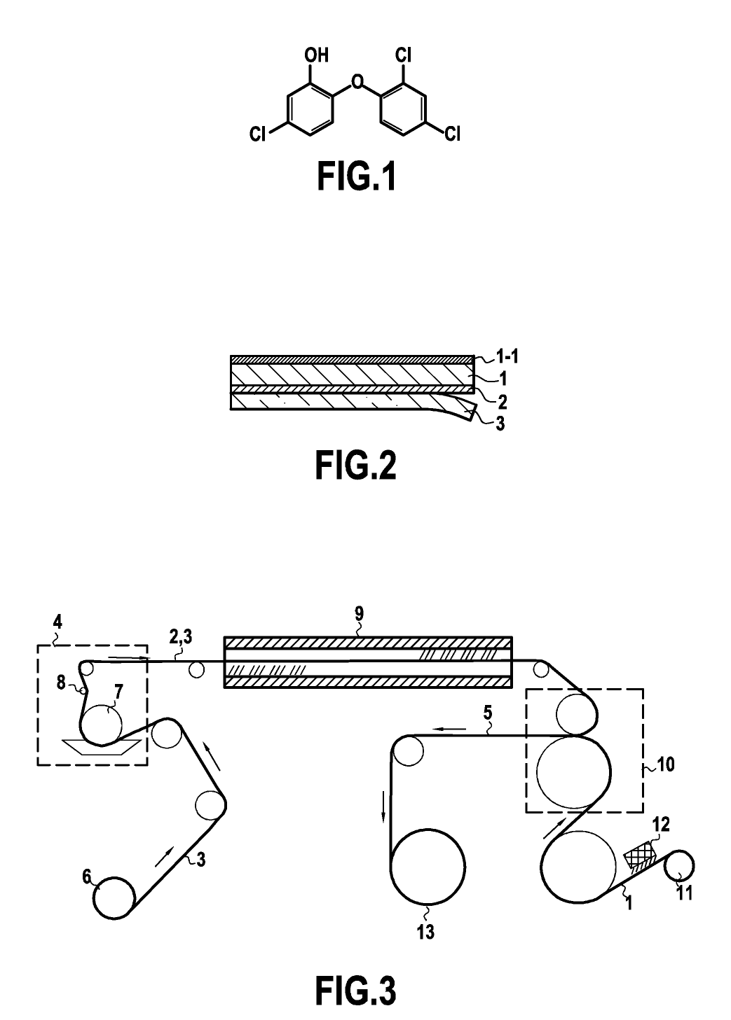

Preferably, the antimicrobial molecule is triclosan the formula for which is shown in FIG. 1; it is also known as 5-chloro-2-(2,4-dichlorophenoxy)phenol or 2,4,4′-trichloro-2′-hydroxydiphenyl ether. It is in the form of a white powder comprising a phenol and an ether function.

Triclosan has activity against the majority of Gram+ and Gram− type bacteria. It acts on their cytoplasmic membrane, preventing synthesis thereof and thus reproduction of the bacteria. More generally, triclosan attacks an enzyme present in many microbes, enoyl-ACP-reductase, which prevents them from assimilating certain fats that are vital to their survival. It is bacteriostatic in low concentrations and bactericidal at high concentrations. Pseudomonas aeruginosa is not affected and penicillin-resistant Staphylococcus aureus is simply inhibited. It has also recently been demonstrated that the composition is highly effective in combating malaria. It is used in a wide variety of domestic, cosmetic and detergent products and even in products applied to the skin or not mentioned above.

Preferably, said adhesive is a pressure-sensitive adhesive that is preferably removable.

The meanings of the terms are as follows:
“pressure-sensitive” means an adhesive that only achieves its definitive adhesive properties after being pressed onto the application surface; and
“removable” means an adhesive that has a stronger affinity for the plastics film than for the surface of the object and that can be peeled from said object surface, in particular being peelable with a peeling force of less than 10 N/inch (400 N/m), preferably less than 5 N/inch (less than 200 N/m), such that the film can be removed without using stripping equipment.

The adhesive properties, i.e. the capacity of the adhesive to create a bond by interaction between its support (namely the plastics film) and the surface of the object to be bonded characterized by three parameters: wettability, peel, and tack.

Wettability represents the capacity of the adhesive deposited on the film to spread over the surface of the object to be bonded. The wettability must be as high as possible so that the contact between the surface to be bonded and the adhesive is as high as possible.

Peel represents the capacity of the adhesive to adhere and thus remain on the surface of the object and the plastics film after having been pressed appropriately. Peel is, for example, determined using American standard ASTM D-1000-78, which consists of measuring the force (in N/inch) necessary to pull an adhesive strip off a standard support. The higher this force is, the more the adhesive grips the support (it depends, inter alia, on the quantity and the nature of the adhesive deposited in g/m²). If a portion of the adhesive remains on the surface to be bonded after being removed, this is termed cohesive rupture or adhesive transfer, which is generally undesirable. It may thus be advantageous to use a temporary adhesive to be able to renew the antimicrobial protection when all of the antimicrobial agent has been exhausted.

Tack represents the instantaneous ability to bond with the support. It is measured using a standardized method similar to the above, for example ASTM D 907-82 (1985). It still measures a force in N/inch that must be high enough for the adhesive to bond with the support immediately. The measurement method consists of bringing an adhesive film into contact with a glass surface with the same width as the film. Generally, the contact surface between the film and the glass is 1 inch², i.e. 6.5×10⁻³ m². This film is then immediately removed using a dynamometer, measuring the force necessary for detachment.

Permanent and removable pressure-sensitive adhesives are known (Handbook of pressure-sensitive adhesive, Ed D Satas, Van Nostran Neinhold, New York 2^{nd} Ed (1989)). They are principally elastomers having adhesive properties. In order to be coated onto the plastics film, the adhesive must be in the fluid form. The following various means are used to transform the tacky elastomer into an applicable fluid product:
dissolving the elastomer in a solvent. These are then termed solvent phase adhesives. These are the products that are used most frequently;
dispersing the elastomer in water by adding surfactants. These are termed aqueous phase adhesives. The surfactant is not eliminated during coating; it remains in the adhesive and causes moisture sensitivity that is usually undesirable;
liquefaction of the elastomer at high temperature for “hot melt” or calanderable adhesives. This product type requires specific and more expensive coating systems;
functionalization and solubilization of the elastomer in reactive monomers with UV curable adhesives. This is an even more expensive technique.

The term “elastomer” here means an “elastic” polymer which tolerates very large deformations (more than 100%) that are at least partially reversible.

The elastomers are classified into three categories: natural rubbers, synthetic rubbers, and polyacrylates.

Rubbers, whether natural or synthetic, have the advantage of having an immediate high bonding ability but they oxidize readily, leading to a reduction in their adhesive power over time. Examples of synthetic rubbers are styrene/butadiene/styrene (SBS) and styrene/isoprene/styrene (SIS) copolymers. Polyacrylate elastomers have a lower immediate bonding ability, but their adhesion is high and remains stable or even increases over time.

More particularly, the adhesive represents a GSM on the plastics film of 10 g/m² to 150 g/m², preferably 20 g/m² to 50 g/m².

The present invention also pertains to a self-adhesive antimicrobial film comprising a said plastics film coated with an adhesive, said film being flexible and manually stretchable to be capable of following the contour of a non-plane surface, said film incorporating an antimicrobial agent at least on the outer surface of said film as defined above.

More particularly, an antimicrobial self-adhesive film of the invention comprises a said plastics film having a thickness of 10 μm to 500 μm, and/or a GSM of 10 g/m² to 1000 g/m², coated with an adhesive layer at 1 g/m² to 150 g/m², with a weight content of antimicrobial agent of 0.01% to 10%, preferably 0.1% to 5% relative to the total weight of film (including the varnish if appropriate) and/or a microbial agent with a mass per unit area of 0.01 g/m² to 100 g/m², preferably 0.05 g/m² to 10 g/m², if appropriate with a said varnish layer of 5 μm to 50 μm and/or with a mass per unit area of 1 g/m² to 100 g/m², preferably 5 g/m² to 50 g/m².

The present invention also pertains to a multilayered composite comprising an antimicrobial self-adhesive film of the invention, the face of said film that is coated with adhesive being applied to a temporary protective liner comprising a layer of paper or a second non adhesive film, said liner preferably having a mass per unit area of 50 g/m² to 200 g/m².

Preferably, before use in a protection method of the invention, said self-adhesive plastics film is in the form of a said multilayered composite as shown in FIG. 2, the adhesive-coated face of said film being applied to a layer of paper or a second non adhesive film, the surface of which may be smooth, embossed or structured, generally denoted the “liner”, which liner protects the adhesive.

The liner, more routinely termed a “release liner”, is a second non-tacky film or, preferably, a sheet of paper coated with a release layer, especially a layer of a polymer such as polysiloxane or fluorinated polymer, intended to cover and thus protect the layer of adhesive on the surface of said plastics film prior to its application. Although it is separated from the antimicrobial plastics film after application, the quality of the liner influences the quality of the bonded antimicrobial film. As an example, using a structured liner facilitates application of the film, reduces the number of bubbles created between the film and the object and thus improves the surface quality of the applied antimicrobial film. Similarly, a liner having a back that has a rough structure, transfers its roughness by pressure to the surface of the antimicrobial film as it is rolled up, thereby modifying its surface properties. The liner is selected by taking the following parameters into account:
The release effect, i.e. non tacky effect, must be adapted to the nature of the adhesive of the antimicrobial film. Too high a release force complicates detachment of the self-adhesive antimicrobial film. If it is too low, the film risks falling off. In general, the value of the release force must be in the range 0.5 N/inch to 2 N/inch (in the range 20 N/m to 80 N/m), preferably 0.8 N/inch to 1.2 N/inch (in the range 30 N/m to 50 N/m). The release effect is provided by a polysiloxane release layer, the liner then being termed silicone paper or, more rarely, a fluorinated polymer. The release layer generally has a thickness of less than 2 micrometers.

The liner body provides the antimicrobial self-adhesive film with dimensional stability prior to use. Its surface quality is important since its structure is impressed by pressure onto the antimicrobial self-adhesive film as the roll is rolled up. The following different liner bodies exist:
calendered kraft and glassine papers that represent the vast majority of available liners. They are used in the majority of applications. Their principal drawback is a papery type surface condition that may mark the surface of the media. Further, their moisture sensitivity may cause the paper to crinkle. To reduce this effect, certain liner papers are coated with a layer including clay particles—these are then termed “clay coated papers”;
papers coated with a layer of polyethylene on one or both faces (PE/paper/PE). It is a composite that is intended to reduce the sensitivity of the liner to water. The presence of PE on the back of the paper also improves the slip of the films and facilitates rolling them up. A polysiloxane type release layer on the adhesive layer side of the plastics film is still required, however;
polyester films or, more precisely, PET, may be used to protect antimicrobial self-adhesive films that have to be completely transparent, for example for films intended to provide window glass with antimicrobial protection.

The protective release liner (including its release layer) has a GSM of 50 g/m² to 200 g/m², preferably 80 g/m² to 150 g/m²;
The antimicrobial self-adhesive plastics film of the invention and the release liner are packaged into the form of rolls with wound lengths of 1 m to 5000 m and with a width of 615 mm to 2000 mm.

The adhesive is applied to the antimicrobial plastics film by coating, consisting of depositing the adhesive layer at a controlled thickness on the film before protecting it with the liner. In general, two known production modes can be distinguished:
direct coating: the adhesive is deposited directly onto the film to be bonded then dried. This method is the simplest to carry out;
transfer coating: the above method has risks for films with too high a thermal sensitivity, such as PVC. The post-coating step of drying the adhesive could deform the film. It is then preferable to coat by transfer or lamination as shown in FIG. 3. The adhesive is initially coated onto the release liner, dried then laminated to the film such as a PVC film in a lamination station placed at the end of the production line.

In a particular implementation of a method for the antimicrobial protection of a large surface of an object, the following steps are carried out:
1/depositing a composite of the invention on the surface of the object to be protected, comprising a self-adhesive film the inner adhesive coated face of which is applied to a temporary protective liner, so as to cut the composite roughly, i.e. to a size that is slightly larger than the exact dimensions of the surface of the object to be protected; and
2/removing a portion of the liner to disclose a portion of the adhesive-coated face of the self-adhesive film, said portion forming a strip, for example; then
3/bonding said strip of self-adhesive film by exerting a pressure on the outer face of said film against the surface to be protected, such that the adhesive adheres to said object surface and the film completely follows the contours, which may not be plane; and
4/if appropriate, simultaneously with step 3/, pulling the free end of the composite, the portion of the liner that is removed being located between the surface to be protected and the remaining portion of the composite; and
5/if appropriate, especially when the self-adhesive film released from the liner follows the non-plane portions of the surface to be protected closely, preferably exerting pressure on the outer face of the film using a scraper that is moved to bond the film, eliminating air and thus preventing bubbles forming between the film to be bonded and the surface of the object to be protected by said film; and
6/repeating steps 2/to 5/until the surface of the object to be protected is completely covered with the self-adhesive film bonded to said surface; and
7/cutting the film to the exact dimensions of said surface to be protected, after which the surface of the object to be protected is completely covered with self-adhesive film bonded to said surface.

For small surface areas, the liner can be removed completely in step 2/and in step 3/and the following steps, initially just a portion of the self-adhesive film can be adhered to a portion of the surface to be protected and then the remainder of the film is applied progressively, using a scraper if appropriate, as explained above.

Advantageously, especially with large surface areas, it is possible to completely remove the liner and to moisten the inner adhesive-coated face of the self-adhesive film to be able to rest it on the surface to be protected without it adhering before pressure has been exerted, in particular using a scraper as explained above.

Other characteristics and advantages of the invention become apparent from the following examples in which:

FIG. 1 shows the formula for triclosan;

FIG. 2 is a diagrammatic representation of a multilayered composite of the invention, comprising: liner 3/adhesive 2/antimicrobial plastics film 1 optionally coated with a varnish 1-1;

FIG. 3 is a diagrammatic representation of a transfer coating station that can coat the adhesive onto the antimicrobial film by transfer from a liner;

FIGS. 4-1 to 4-7 show dishes containing bacterial culture media and samples in the form of disks of self-adhesive film coated with an antimicrobial varnish of Examples 1 to 7 respectively;

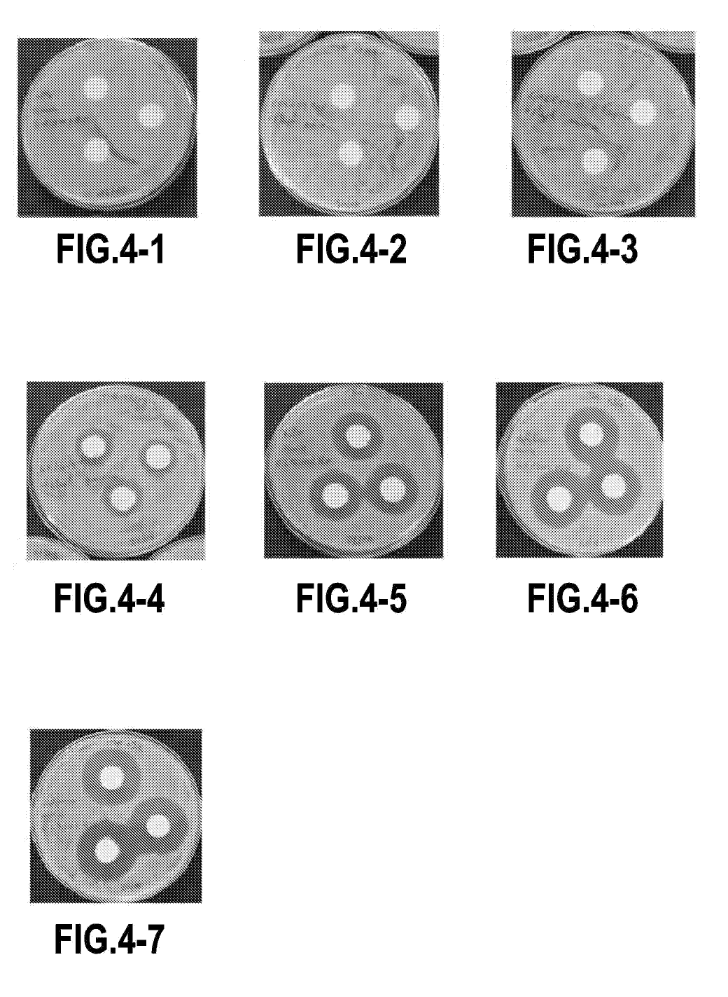

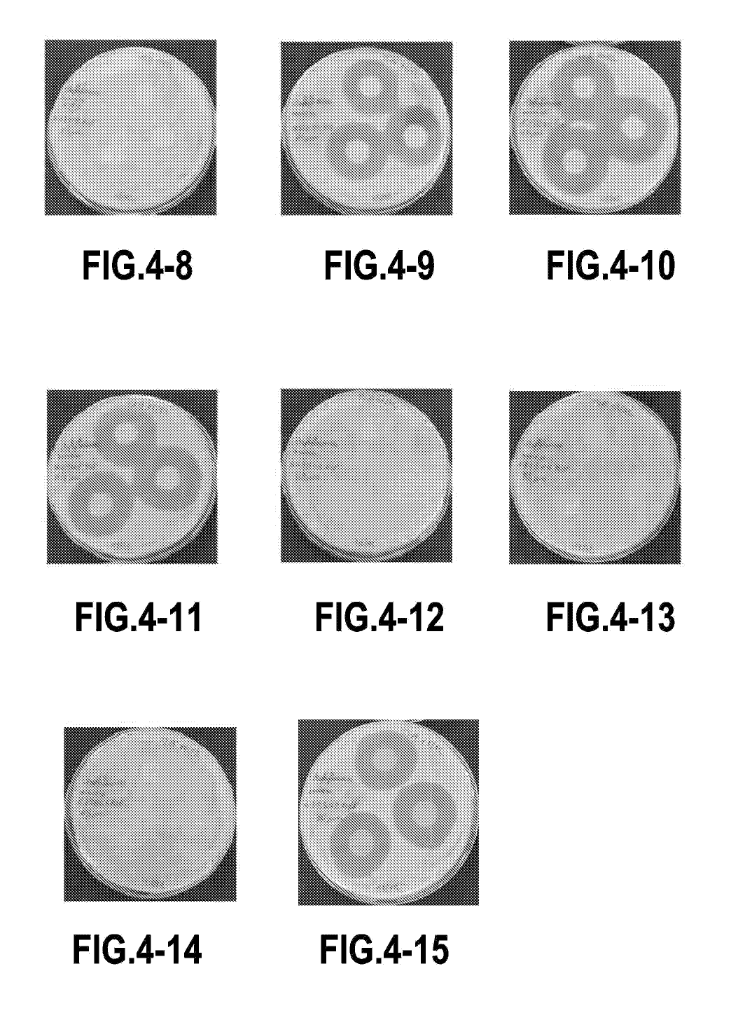

FIGS. 4-8 to 4-15 show dishes containing bacterial culture media and samples in the form of disks of self-adhesive film incorporating in its material an antimicrobial agent from Examples 8 to 15 respectively;

FIGS. 5-1 to 5-6 show the application of a self-adhesive film of the invention to a plane surface;

FIGS. 6-1 to 6-6 and 7-1 to 7-3 show the application of a film of the invention to non-plane surfaces such as automobile bodywork (FIGS. 6-1 to 6-6) or a sink drainer (FIGS. 7-1 to 7-3).

### 1. METHOD OF MANUFACTURING AN ANTIMICROBIAL SELF-ADHESIVE PVC FILM

### 1.1 Preparation of an Antimicrobial Varnish

### 1.1.1. Varnish 1 of Examples 1 to 5

5 parts by weight of a solid photoinitiator such as benzophenone was dissolved in 34 parts by weight of the reactive bifunctional dipropylene glycol diacrylate monomer. Following complete dissolution of the benzophenone, 10 parts by weight of a co-initiator of the tertiary amine type such as Craynot CN-371 supplied by Sartomer was added to the preceding mixture. Next, 50 parts by weight of a urethane diacrylate oligomer supplied by Sartomer under the trade name Craynor CN-981, 1 part by weight of a wetting agent such as the silicone polymer Tego Wet 500 supplied by Degussa were added. The antimicrobial agent was then added to the above mixture until it had dissolved completely. The whole was mixed and heated to a temperature of 40° C. until a fluid, completely transparent mixture was obtained.

### 1.1.2. Varnish 2 of Example 6

3 parts by weight of a solid hydroxyphenyl ketone type photoinitiator such as Irgacure 184 supplied by CIBA was added to 0.5 parts by weight of another solid phosphine oxide type photoinitiator such as Darocur TPO, also supplied by CIBA. These two photoinitiators were dissolved in 39 parts by weight of a monofunctional acrylate monomer such as Ebecryl IBOA supplied by Cytec. Next, 57 parts by weight of a polyester acrylate oligomer such as that supplied by Sartomer under the trade name Craynor UVP-210 and 0.5 parts by weight of a non silicone wetting agent such as Modaflow 9200 supplied by Cytec were added. The antimicrobial agent was then added to the above mixture until it dissolved completely. The whole was mixed and heated to a temperature of 40° C. until a completely transparent fluid mixture was obtained.

### 1.1.3. Varnish 3 of Example 7

This was varnish 2 to which 0.5 parts by weight of a slip agent supplied by Degussa under the trade name Tego Rad 2300 was added.

An antimicrobial agent was mixed into the liquid varnish in an amount by weight of antimicrobial agent of 1% to 2% in the varnish, to obtain self-adhesive films the varnish of which, after application, contained 1% or respectively 2% by weight of antimicrobial agent as specified in the description of the products of Examples 1 to 7 below.

### 1.2. Coating Varnish onto Plastic PVC Film

Light used to dry the varnish had the secondary effect of causing the PVC strip to heat up greatly. The tension then exerted by the machine on the film risked stretching it in an uncontrolled manner and breaking it. This risk is eliminated if the PVC film has initially been adhered to a liner the thermal stability of which is sufficient for it not to be deformed under the joint action of heat and tension. For this reason a paper/PE liner was selected with a surface density in the range 50 g/m² to 200 g/m², preferably a surface density in the range 80 g/m² to 150 g/m².

The varnishes were deposited on a calendered white plasticized PVC film with a thickness of 80 μm and 115 g/m² with an elongation at break of 120% and an ultimate tensile strength of 40 N/inch (1575 N/m). This PVC film comprised 30% of a polymeric plasticizer constituted by a polybutanediol adipate.

The PVC film had been coated with a layer of 30 g/m² of a solvent based pressure-sensitive acrylic adhesive. This adhesive is commercially available under the trade name Gelva Multipolymer Solution 2775 from Monsanto. Said adhesive was laminated onto a paper/PE liner from Poly Slik commercially available from Loparex with a GSM of 145 g/m² as described below (paragraph 1.4).

The varnishes were deposited in thicknesses of less than 20 μm, corresponding to 22 g/m′ onto the PVC film and dried under Fusion VPS600 UV lamps at a speed of 10 m/min. The varnish was deposited using a Mayer rod using the same procedure as that described for coating the adhesive. The elongation at break of the self-adhesive film coated with varnish measured under the standard conditions of standard NF X 41-025 was greater than 50% and its break strength was 39 N/inch.

### 1.3 Manufacture of a PVC Film Incorporating an Antimicrobial Agent in its Material

A transparent cast PVC was prepared from the following mixture:
40 parts by weight of a distilled light aromatic solvent cut such as Hi-Sol 10 (C₈ to C₁₀ aromatics) obtained from Ashland Chemical. This was mixed with 13 parts by weight of a heavy hydrotreated (C₆ to C₁₃) oil distillate fraction obtained from Exxon Mobil under the trade name Isopar G;
4 parts by weight of a hydroxy-benzophenone type UV absorber supplied by Great Lakes Chemical Corporation under the trade name lowilite 22, 6 parts by weight of a barium/zinc-based thermal stabilizer available from Crompton (Chemtura Corp) under the trade name Mark 4718 and 8 parts by weight of G-59 plasticizer that is a glycol polyadipate supplied by C P Hall Corp, were dissolved in the mixture of solvents;
100 parts by weight of a Solvin 380 NS polyvinyl chloride powder obtained from Solvay was dispersed in the above mixture with vigorous stirring until no solid particles could be seen in the mixture;
finally, 1.2, 2.4 or 3.7 parts by weight of microbial agents was added to the mixture to obtain a dry extract quantity by weight of 1.2% or, respectively, 3% of antimicrobial agents incorporated into the material of the PVC film, as mentioned in the description of Examples 8 to 15 below. The PVC film obtained thus comprised 6.6% by weight of said polymeric plasticizer.

The formulation was deposited on a PET backing covered with a release treatment. This backing is commercially available under the trade name Mylar 834 from Dupont Teijin Films. Coating was carried out using a Mayer rod as explained in FIG. 3 and in paragraph 1.4 for the adhesive coating. Deposition was carried out so as to obtain a film with a final thickness of 50 μm and 68 g/m². The speed of the coating line was thus 10 m/min. The film passed into an oven at a fixed temperature of 200° C. to evaporate off all of the solvents and to obtain a completely smooth, homogeneous film. It was then cooled before being rolled up into a 2000 linear meter roll.

### 1.4. Coating of Adhesive onto Film and Manufacture of a Liner/Antimicrobial Self-Adhesive Film Composite

A large number of coating methods are known. They are common to all industries that deal with depositing layers onto plane surfaces. Examples are air blade coating, knife on cylinder coating, floating knife coating, cylinder on cylinder coating, direct or reverse three or four roll coating, Mayer rod coating, coma bar coating or methods normally used by printers such as flexography, heliography, etc. Preferably, coma bar and Mayer rod coating are used. Mayer rod coating is illustrated in FIG. 3.

A Mayer rod coating head 4 is composed of a wire wound rod 8 placed downstream of a coating cylinder 7. The thickness of the wire and the tension exerted on the liner 3 means that the thickness of the adhesive 2 that is deposited can be adjusted to 30 g/m².

Once coated with adhesive 2, the liner 3 passes into an oven 9 the temperature of which is in the range 40° C. to 120° C. More precisely, the oven is divided into four compartments the temperatures of which are respectively 50° C., 60° C., 90° C. and 120° C. The aim of the operation is to evaporate off the solvents from the adhesive 2. Lamination takes place at its outlet in a lamination station 10 which laminates the liner 3 coated with adhesive against the PVC film 1 to form a multilayered composite 5. The PVC film 1 that has been unrolled in the vicinity will initially have undergone a corona, flame or plasma type surface treatment at 12 to improve the bonding ability of the adhesive onto its surface.

After lamination of the adhesive-containing liner with the PVC film at 10, the finished product 5 (liner+antimicrobial self-adhesive film composite) that is still hot is cooled to bring it back to ambient temperature and prevent any subsequent contraction. It is then rolled up at 13 into a roll of 2000 m then cut off as required.

The liner 3 (Loparex Poly Slik) has a GSM of 145 g/m² and the adhesive 2 has a GSM of 30 g/m². The series of coating and lamination operations is carried out at a speed of 20 m/min.

### 2. ANTIMICROBIAL PROPERTIES OF FILMS COVERED WITH AN ANTIMICROBIAL VARNISH

The examples below are of self-adhesive films coated with a varnish with antimicrobial properties. The varnishes had the compositions mentioned in paragraph 1.1 above and were deposited on a calendered white PVC film with a thickness of 80 μm as described in paragraph 1.2 above. The film was coated with a solvent-based acrylic adhesive to a thickness of 25 μm by laminating to a paper liner coated with a layer of PE and polysiloxane and having a GSM of 145 g/m² as described n paragraph 1.4 above.

The antimicrobial activity of the films was determined using the inhibition zone method, similar to that described in Japanese standard JIS L 1902: 2002. The film was cut into small disks with a diameter of 1 cm. They were immersed in a dish containing a nutrient medium and a known quantity of yellow colored Staphylococcus aureus bacteria. After incubating for 24 hours, the bacteria had colonized all of the dish apart from in the proximity of the samples treated with the antimicrobial varnish which they did not succeed in approaching. A protective halo was formed around the treated samples that was termed the inhibition zone, as shown in FIGS. 4-1 to 4-15 representing the results for the antimicrobial films of Examples 1 to 15. Measuring this halo allowed the intensity of the antimicrobial activity of the film to be determined.

### Example 1

Matt white polymeric PVC (i.e. including a polymeric plasticizer) rendered tacky using an acrylic adhesive deposited on a PE paper liner. Unvarnished control product. Inhibition area: 0 mm.

### Example 2

Matt white polymeric PVC rendered tacky using an acrylic adhesive deposited on a PE paper liner. Varnish 1 of paragraph 1.1 containing 1% by weight of the antimicrobial agent Irgaguard H6000 (silver salt). Inhibition area: 0 mm.

### Example 3

Matt white polymeric PVC rendered tacky using an acrylic adhesive deposited on a PE paper liner. Varnish 1 of paragraph 1.1 containing 1% by weight of the antimicrobial agent Parmetol CF10 (mixture of zinc pyrithione and terbutryn). Inhibition area: 0 mm.

### Example 4

Matt white polymeric PVC rendered tacky using an acrylic adhesive deposited on a PE paper liner. Varnish 1 of paragraph 1.1 containing 1% by weight of the antimicrobial agent Irgaguard B1000 (triclosan). Inhibition area: 3 mm.

### Example 5

Matt white polymeric PVC rendered tacky using an acrylic adhesive deposited on a PE paper liner. Varnish 1 of paragraph 1.1 containing 2% by weight of the antimicrobial agent Irgaguard B1000 (triclosan). Inhibition area: 7 mm.

### Example 6

Matt white polymeric PVC rendered tacky using an acrylic adhesive deposited on a PE paper liner. Varnish 2 of paragraph 1.1 containing 2% by weight of the antimicrobial agent Irgaguard B1000 (triclosan). Inhibition area: 8 mm.

### Example 7

Matt white polymeric PVC rendered tacky using an acrylic adhesive deposited on a PE paper liner. Varnish 3 of paragraph 1.1 containing 2% by weight of the antimicrobial agent Irgaguard B1000 (triclosan). Inhibition area: 9 mm.

The influence of the nature of the varnish on the antimicrobial properties of the films should be noted.

At the same concentration of triclosan, varnishes 2 and 3 (polyesters) showed a higher antimicrobial activity than varnish 1 (polyurethane).

Further, triclosan (Irgaguard B1000) appeared to be more effective than Parmetol CF10 and Irgaguard H6000.

Other varnishes and other antimicrobial agents were tested, as mentioned above.

### 3. PROPERTIES OF SELF-ADHESIVE FILMS INCORPORATING AN ANTIMICROBIAL AGENT IN ITS MATERIAL

The samples tested in Examples 8 to 15 were transparent cast PVC rendered tacky with a solvent-based acrylic adhesive 25 μm in thickness. They were laminated to a PE paper liner with a density of 145 g/m². Their elongation at break measured under the standardized conditions of standard NF X 41-025 was more than 100%.

This was cast PVC obtained using the coating method described above in paragraph 1.3 and rendered tacky as described in 1.4.

These examples again show that of the antimicrobial molecules tested, triclosan had the highest antimicrobial activity in a film that could be measured using a standard similar to JIS L 1902:2002. A comparison between Examples 9 and 15 shows that the thickness of the film has no direct correlation with the antimicrobial effectiveness; it is rather the concentration of the antimicrobial agent in the film than its total GSM that is correlated with its effectiveness. However, the total GSM has an effect on the duration of the antimicrobial effectiveness for a given film.

### Example 8

Transparent cast PVC with a thickness of 65 μm. It contained no antimicrobial agent. Inhibition area: 0 mm.

### Example 9

Transparent cast PVC with a thickness of 60 μm. It contained 1% by weight of Irgaguard B1000 (triclosan). Its inhibition area was 9 mm.

### Example 10

Transparent cast PVC with a thickness of 60 μm. It contained 2% by weight of Irgaguard B1000 (triclosan). Its inhibition area was 11 mm.

### Example 11

Transparent cast PVC with a thickness of 64 μm. It contained 3% by weight of Irgaguard B1000 (triclosan). Its inhibition area was 11 mm.

### Example 12

Transparent cast PVC with a thickness of 52 μm. It contained 2% by weight of Irgaguard H6000 (silver salt). Its inhibition area was 0 mm.

### Example 13

Transparent cast PVC with a thickness of 65 μm. It contained 2% by weight of Irgarol 1051 (N′-WHUW-butyl-N-cyclopropyl-6-(methylthio)-1,3,5-triazine-2,4-diamine). Its inhibition area was 0 mm.

### Example 14

Transparent cast PVC with a thickness of 65 μm. It contained 2% by weight of Parmetol CF 10 (mixture of zinc pyrithione and terbutryn). Its inhibition area was 0 mm.

### Example 15

Transparent cast PVC with a thickness of 30 μm. It contained 1% by weight of Irgaguard B1000 (triclosan). Its inhibition area was 9 mm.

A comparison of the various examples demonstrates the superiority of triclosan over the other antimicrobial agents that were tested.

### 4. OBJECT PROTECTION EXAMPLES

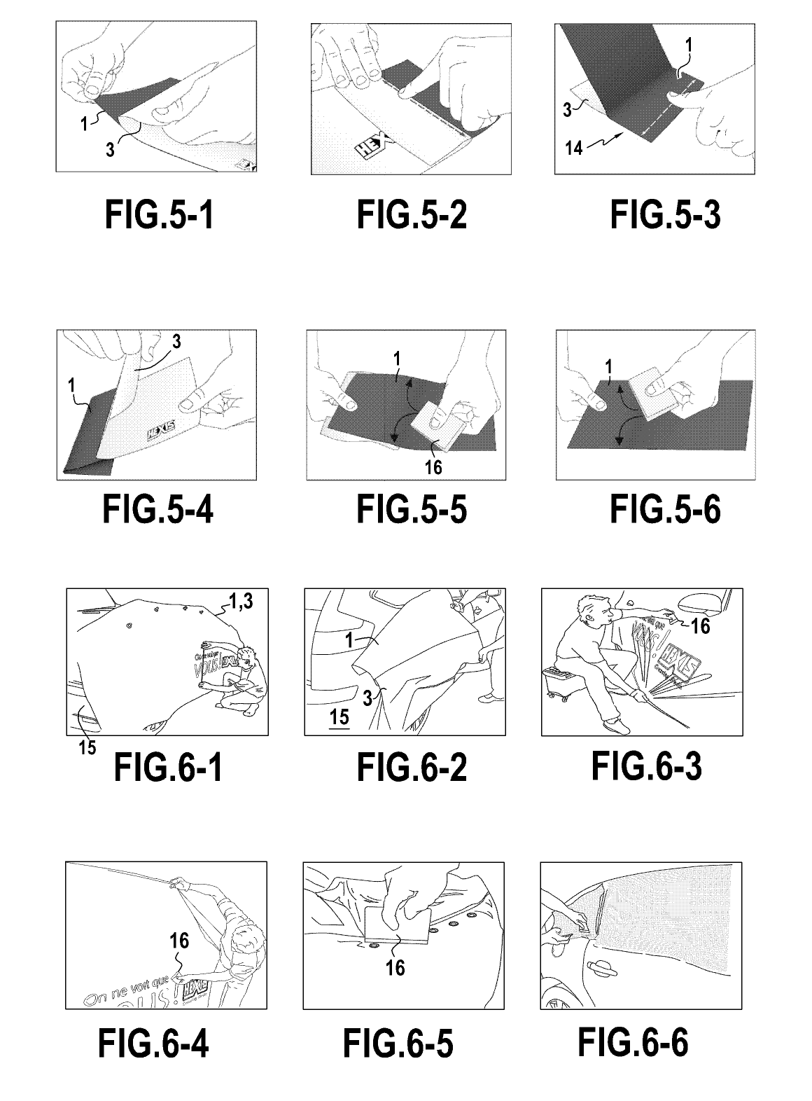

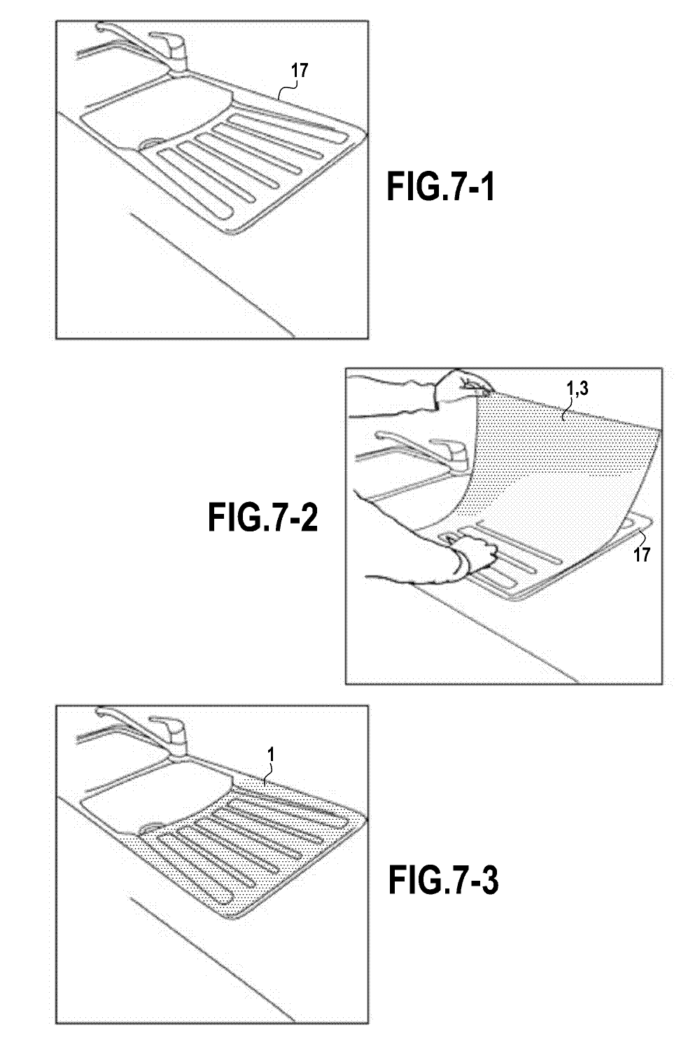

4.1. The protection of an object with a plane surface is represented in FIGS. 5-1 to 5-6. A film of antimicrobial PVC 1 is deposited on a surface 14. Firstly (FIG. 5-1), a portion of the liner 3 is removed from the PVC film 1 over a strip of a few centimeters. The portion of the liner that has been released is then folded over its whole width (FIG. 5-2) so that only said strip of film is exposed. This strip is deposited (FIG. 5-3) on the surface to be protected 14 by exerting a pressure on the outer face of the PVC film to be bonded, so that the adhesive adheres completely to said surface. The liner 3 is then gradually removed by pulling on the detached portion of the liner, this then being placed between the film and the surface of the object that is not yet protected. Next, the portion of the self-adhesive film that has thus been released from the liner is applied against the surface to be protected, as explained below. A pressure is exerted on the PVC film to be bonded, flattening it against the surface to be protected with a scraper 16 and by moving the scraper over the film, to eliminate air and prevent the formation of air bubbles between the film and the surface to be protected (FIGS. 5-5 and 5-6).
4.2. The protection of an object 15 with a particularly complex curved surface is shown in FIGS. 6-1 to 6-6. The object 15 in question is the bodywork of an automotive vehicle. The PVC film 1 and its liner 3 are deposited on the object to be protected to be able to measure its exact dimensions (FIG. 6-1). It is roughly cut out, the liner is progressively removed and it is applied to the object 15 in the same manner as described in FIG. 5 by bonding a strip of several centimeters of PVC (FIG. 6-2). Slightly curved surfaces are covered by pulling on the free end of the PVC film composited with its liner, after having removed a portion of the liner, the other end of the film assembly being supported by the portion that has already been bonded (FIG. 6-3). When a portion of the film has been properly positioned, a pressure is exerted on the film to ensure its adhesion to the curved surface (FIG. 6-4), if necessary by simultaneously pulling the free end of the film composited with the liner; using a soft plastic scraper 16 facilitates this operation (FIGS. 6-4 and 6-5). Finally, when the whole surface of said object is covered, the film is cut more precisely (FIG. 6-6).
4.3. Protection of an object 17 with a surface of relatively small dimensions is shown in FIGS. 7-1 to 7-3. The object 17 in question represents the drainer of a sink (FIG. 7-1). The PVC film 1 is deposited on the object so as to take up its dimensions and cut to roughly fit it. It is then completely removed from its liner 3 and applied to the object 17 in the manner described in FIG. 5, by bonding a strip of a few centimeters of PVC 1. Curved surfaces are covered by pulling on the PVC, the portion that has already been bonded supporting the film assembly (FIG. 7-2). When a portion of the film 1 has been properly positioned, a soft plastic scraper 16 is used to facilitate application of the remainder of the film, as explained above. The film will be cut more accurately after protecting the whole of the object 17 (FIG. 7-3).

1. A method for the antimicrobial protection of a plane or non-plane surface of a material object, comprising applying against the surface of the object an inner face of a self-adhesive plastics film, the film being coated on said inner face with a layer of adhesive which is applied against the surface of the object, said film comprising plasticized PVC, said plasticized PVC film comprising a polymeric plasticizer in a proportion of 5% to 50% by weight in said film, said film being flexible and manually stretchable and capable of following any contour of said surface, the film having an elongation at break of more than 50% and an ultimate tensile strength of less than 6000 N/m, and said film having a composition incorporating, or having disposed on an outer surface thereof, an antimicrobial agent rendering the outer surface of said film active against microbes.

2-17. (canceled)

18. A method according to claim 1, wherein said polymeric plasticizer is selected from the group consisting of polyesters obtained by reacting a diol with a dibasic acid.

19. A method according to claim 1, wherein that the antimicrobial agent is incorporated into a varnish applied to the outer surface of the plastics film, preferably in an amount by weight of 0.1% to 10%, more preferably 0.5% to 5% relative to the weight of said varnish.

20. A method according to claim 1, wherein the antimicrobial agent is incorporated into a varnish applied to a calendered plasticized PVC film.

21. A method according to claim 20, wherein said calendered plasticized PVC has an elongation at break of less than 200%, preferably less than 150%, more preferably 50% to 100%.

22. A method according to claim 1, wherein the antimicrobial agent is incorporated into an acrylic polymer-based varnish, preferably acrylic polyester that can be polymerized by curing in light.

23. A method according to claim 1, wherein the antimicrobial agent is incorporated into the composition of the plastics film, preferably in an amount by weight of 0.1% to 10%, more preferably 0.5% to 5% relative to the weight of the film.

24. A method according to claim 23, wherein the antimicrobial agent is incorporated into the composition of a plastic plasticizer PVC film prepared by coating, and termed cast PVC, having an elongation at break of more than 100%.

25. A method according to claim 1, wherein the antimicrobial agent is triclosan.

26. A method according to claim 1, wherein said adhesive is a pressure-sensitive adhesive.

27. A method according to claim 1, wherein said adhesive is a removable adhesive.

28. A method according to claim 1, wherein said surface of the object is a non-plane surface.

29. A method according to claim 1, wherein said surface of the object is formed from a material selected from the group consisting of wood, rigid plastic materials, plastics, minerals and metals.

30. A method according to claim 1, wherein said object is a household object, an item of furniture or an interior building fitting, preferably for locations that are open to the public and exposed to a risk of contamination by contact with said object.

31. An antimicrobial self-adhesive film comprising a plastics film formed from plasticized PVC coated with an adhesive, said film being flexible and manually stretchable in order to be capable of following the contour of a non-plane surface, said film having a composition incorporating, or comprising on a surface thereof, an antimicrobial agent.

32. An antimicrobial self-adhesive film according to claim 31, wherein said plastics film has a thickness of 10 μm to 500 μm and a mass per unit area of 10 g/m² to 1000 g/m², and is coated with a layer of adhesive at 1 g/m² to 150 g/m², having an amount by weight of antimicrobial agent of 0.01% to 10%, preferably 0.1% to 5% relative to the total weight of the film, and a mass per unit area of 0.01 g/m² to 100 g/m², preferably 0.05 g/m² to 10 g/m² of antimicrobial agent and, optionally, a layer of varnish of 5 μm to 50 μm in thickness, with a mass per unit area of 1 g/m² to 100 g/m², preferably 5 g/m² to 50 g/m².

33. A multilayered composite comprising an antimicrobial self-adhesive film in accordance with claim 31, the adhesive-coated face of said film being applied to a temporary protective liner comprising a layer of paper or a second release film, said liner preferably having a mass per unit area of 50 g/m² to 200 g/m².
